(19) United States
(12) Patent Application Publication
(10) Pub. No.: US 2002/0166075 A1
(43) Pub. Date: Nov. 7, 2002

(54) Low power interface between a control processor and a digital signal processing coprocessor

(76) Inventors: Sanjay Agarwal, Santa Clara, CA (US); Sapna Agrawal, Santa Clara, CA (US)

Correspondence Address: Sanjay Agarwal, CHIPSOL, Inc., 4702 Cheeney St., Santa Clara, CA, 95054, US

(21) Appl. No.: 09/849,823

(22) Filed: May 4, 2001

(51) Int. Cl. G06F 1/26; G06F 1/32

(52) U.S. Cl. 713/320

(57) ABSTRACT

Industrial electronics and many consumer applications need lower cost, lower power consumption, control processing, and some DSP function capability. The technique described implements a system design with industrial and consumer applications in mind. The processor coprocessor architecture with freeze state method to implement power management also provides efficient software programming. Higher number of DSP computations can be programmed as hardware coprocessors functions. Recognizing the completion of DSP computation and implementing power management based on that can be a hardware function. This method of combining DSP computations and power management results in system that can find widespread use in industrial and consumer applications. The technique of using freeze state and implementing power management can also be used in non-battery applications in which power conservation is required.

### CROSS-REFERENCE TO RELATED APPLICATIONS

This application is related to U.S. patent application Ser. No. 09/841,536 titled “COPROCESSOR ARCHITECTURE FOR CONTROL PROCESSORS USING SYNCHRONOUS LOGIC” filed on Mar. 24, 2001.

### STATEMENT REGARDING FEDERALLY SPONSORED RESEARCH AND DEVELOPMENT

Not Applicable.

### SEQUENCE LISTING

Not applicable.

### REFERENCE TO A MICROFICHE APPENDIX

Not Applicable.

### FIELD OF THE INVENTION

This invention relates in general to integrated circuits, and more particularly to the control processor and a digital signal processing (DSP) coprocessor interface architecture having power management features.

### BACKGROUND OF THE INVENTION

DSP techniques are widely used in the industry in applications like wireless technology, industrial portable instruments, and portable electronics like calculators. Sometimes the portable instrument has to process huge amounts of data before the database servers can receive the data. These portable devices have a need for digital signal processing in portable electronics. Performing DSP functions at the lowest possible power consumption is a top priority for system designers. Low power design also reduces system cost and improves system performance when the system is not portable. Low power consumption results in lower energy costs. Low power consumption by system electronics also translates to smaller enclosures for electronics and correspondingly lesser cooling and ventilation requirements.

DSP algorithms in portable electronics like wireless are implementing algorithms that require complex math computations. Dedicated math units in the integrated circuits normally perform the math computations. Some of the common DSP tasks involve data compression, error correction, and echo cancellation. The logic units used to implement the math functions can be made part of the central control processor or the math unit can be designed as a coprocessor. Most of the control processors are not efficient at handling DSP mathematical functions. This is because the control processors do not provide complex math instructions. Sometimes the control processor may not be capable of handling higher bit-widths required by the DSP algorithm. In other case, it might not be efficient to let the control processor perform DSP computations. If the DSP computations can be off-loaded to some coprocessor, the control processor could be available to perform other tasks required in the system.

Implementation of DSP algorithms in portable and non-portable electronic system involves dedicated logic contained in coprocessors. The objective of systems is to perform the coprocessor functions with a minimum amount of power consumption. The power consumed by any electronic device is the sum total of static power dissipation and dynamic power dissipation. The static power dissipation is due to leakage current. The dynamic power dissipation is due to two factors: a) switching transient current, and b) charging and discharging of load capacitances. The total static power dissipation is obtained as a product of leakage current and supply voltage for all the individual devices comprised in the integrated circuit. The switching of devices from logic 1 to logic 0 and logic 0 to logic 1, in the devices causes a short current pulse from supply voltage to ground. The dynamic power consumption in the circuit is given as a product of C_{L} (load capacitance), and V² (supply voltage squared), and F (frequency of switching). The dynamic power consumption can thus be controlled if we can control the switching characteristics of the sections of the system. A more detailed description of power consumption in electronic circuits is described in the book title “Principles of CMOS VLSI Design—A Systems Perspective” by Neil Weste & Kamran Eshraghian, pages 145-149, which is hereby incorporated by reference.

Superior power management features can be achieved if the hardware and software implementation of the system support power conservation. The objective of the system design is to achieve best possible system level performance with the available hardware and software support and to achieve it at the lowest possible power requirement levels.

Inventors have created several system designs and solutions to achieve power management in processor-coprocessor design in computer systems. Some of the methods and apparatus are as follows:

The power management features can be implemented in a variety of implementations. U.S. Pat. No. 6,219,796 (2001) assigned to David Harold Bartley entitled “Power reduction for processors by software control of functional units” describes one such method. This technique involves design of a system in which the functional units of the processor are independently controllable by instructions. The central processor in this system is designed with the ability of sending instructions to specific functional units to put the functional unit in power-down state. The block diagram in FIG. 1 illustrates this method for optimizing a computer program to reduce power consumption as described in this invention.

Another method for reducing peak power in microprocessor circuits is described in U.S. Pat. No. 5,991,884 (1999) entitled “Method for reducing peak power in dispatching instructions to multiple execution units” assigned to Lin et al. In this technique the attempt is made to reduce peak power by ensuring that two high-power executing units are not executing simultaneously. In this scheme of implementation to reduce peak power, the central control unit prevents dispatch of instruction to second unit as long as the first unit is executing an instruction. The second unit is forced to remain in idle state as long as the first execution unit is processing an instruction. The block diagram representation for this scheme is as shown in FIG. 2.

The microprocessor architecture can also have multiple instruction units that decode the same instruction in parallel. The functional unit can decide if the instruction is intended for the particular block based on this instruction decoding. This technique is described in U.S. Pat. No. 5,495,617 (1996) entitled “On demand powering of necessary portions of execution unit by decoding instruction word field indications which unit is required for execution.” This patent is assigned to Kouichi Yamada. The block diagram in FIG. 3 shows an implementation based on the technique described in this patent.

Lower power consumption can also be achieved by selectively disabling clocking to specific sections of the integrated circuit. Suspending clocks corresponds to suspension of switching power dissipation or the dynamic power dissipation. This method and technique is described in U.S. Pat. No. 5,632,037 (1997) entitled “Microprocessor having power management circuitry with coprocessor support” assigned to Maher et al. A block diagram representation for this technique is as described in FIG. 4. Gated clocks in logic design need specialized handling for synthesizing the logic using industry standard synthesis tools. Also building testability for manufacturing in integrated circuits has to be handled differently, if gated clocks are permitted in logic design.

Power management in the integrated circuit electronics can also be achieved if the external system requests that the system can be in power down mode. In this scheme a clock generation circuitry inside the microprocessor monitors this external signal and controls the application of clocks to the functional blocks within the integrated circuit. Removal of clock from sub-circuits results in removal of switching from the devices. The clock generation circuitry can also notify the external circuitry of the suspended state of the microprocessor. The block diagram for this technique is as described in FIG. 5. This technique of power down implementation is described in U.S. Pat. No. 5,630,143 (1997) entitled “Microprocessor with externally controllable power management” assigned to Maher et al.

Lower power consumption is of extreme importance for portable electronics. U.S. Pat. No. 5,487,181 (1996) entitled “Low power architecture for portable and mobile two-way radios” assigned to Dailey et al. describes a scheme in which multiple processors called power processor and main processor are used to design a system to control power functions. In this method, the power processor performs functions like interrupt controller, tone decoding, synthesizer lock monitoring. The power processor makes sure that the main processor can be in sleep mode as much as possible but can be awaken should the function be required. The block diagram for this architecture description is as shown in FIG. 6.

Some processor coprocessor architecture also focuses on other aspects besides power for efficient interfacing between processor and coprocessor. One such implementation is described in U.S. Pat. No. 5,923,893 (1999) entitled “Method and apparatus for interfacing processor to a coprocessor” assigned to Moyer et al. The technique described in this patent describes a method in which a single processor can support multiple coprocessors. The data transfer in this scenario is moved through a variety of methods including register snooping, broadcast, or specifically through load and store instructions. The block diagram for this technique is as shown in FIG. 7. Such an implementation of processor coprocessor architecture is applicable when power consumption by the system is not a top design priority for the designers.

Another implementation of processor coprocessor is possible by building direct communication with the coprocessor. The direct communication link can comprise of a request line, a busy line, an error line, and an acknowledgement line. The request line from the coprocessor and an acknowledgement line from the microprocessor provide for operand transfer from the coprocessor to microprocessor. A busy line and an error line from the coprocessor allow the microprocessor to monitor the condition of the coprocessor. Data transfer between the microprocessor and the coprocessor can be accomplished using a bidirectional bus. U.S. Pat. No. 4,547,849 entitled “Interface between a microprocessor and a coprocessor” assigned to Louie et al. describes this method of processor coprocessor interfacing. This technique is described in detail in FIG. 8.

In another implementation of interfacing processor to coprocessor, a constant time unit is programmed for the computations in the floating-point unit to be completed. The latency for completion of the specified floating-point operation is specified in terms of number of clock cycles. The latency is then pre-programmed as a count in the timer. Separate timer units are implemented for Arithmetic Logic Unit (ALU) operations, multiply operations, logical operations and divide and square root operations. This technique is described in U.S. Pat. No. 5,021,985 (1991) entitled “Variable latency method and apparatus for floating-point coprocessor” assigned to Hu et al. The architecture implementation is as shown in FIG. 9.

Prior art processor coprocessor interfacing and interfacing for power reduction are focused on achieving superior interfacing by techniques like software control of functional units in which the processor dispatches an instruction to put the specific functional unit in power down state. This effectively means that each functional unit will have the ability to decode the instruction sent to it. This method of implementation has disadvantages because it compels the designer to build special decode units and special instructions for coprocessors.

Operating multiple execution units simultaneously also has the disadvantage that it results in a corresponding power increase in the microprocessor. The microprocessor power fluctuates at various times depending on the number of execution units that are operating at one time. Having multiple execution units would result in “peak power” when all of the execution units are operating simultaneously. The switching in the integrated circuits is responsible for the dynamic power dissipation. Suspending clocks to functional units also provide reduction in power usage. The disadvantage with this method is that you have to design logic in very special way such that gated clocks are permitted in design. Gated clocks make design more complex when the integrated circuit is being built with design for test (DFT) capability. A system can also be built such that we have a dedicated power management processor and a main processor. Though technically feasible, this solution is not feasible financially in most consumer electronics product development projects.

The current industry systems have demand for DSP capability in lower end control processors. The article in EE Times dated Aug. 7, 2000 with title “DSPs ride the app-specific rapids”written by Richard W Blasco, which is hereby incorporated by reference, describes the applications that can be approached with a low end control processor and simple DSP capability. The article describes how makers of consumer products are constantly looking for higher performance in control processors at lower manufacturing costs. This article in EE Times also discusses how the 8-bit controller architecture still dominates the consumer market in the age of Pentium III and Athlons.

Another article in EE Times dated May 3, 1999 by David Lammers, Will Wade, and Peter Clarke titled “Leading-edge RISC processors cut power to the core”, which is hereby incorporated by reference, describes how a new class of embedded RISC (reduced instruction set computer) processors have emerged to compete in consumer and communications applications. The article then describes how very few applications at consumer market level need the capability and sophistication of 32-bit and 64-bit architectures for efficient implementation. The consumer market is very cost sensitive. The reason to adopt 32-bit or 64-bit processing capability has to be very compelling. Also, the size of implementing logic for 32-bit or 64-bit processors is significantly higher compared to 8-bit or 16-bit processors. Larger size of the integrated circuit also translates into a correspondingly higher manufacturing cost.

Still another article in EE Times dated Aug. 7, 2000 titled “Cores push low-power envelope” by Daniel Martin, and J. Geoffrey Chase, which is hereby incorporated by reference, describes the importance of low power circuit and logic implementations. The authors discuss a mobile communication system in this article and they mention that this system consisting of many different sub-systems requires application specific instructions or hardware or both to create an efficient overall design. The article describes how CPU architectures are now marking low clock frequency as a marketing advantage. As discussed in prior art, the higher switching activity corresponds to higher power consumption. Having the capability to run at lower clock rates can be a system design advantage when implementing power optimal electronics. The article describes power management of internal units as well as the ability and protocols to control the power status of peripherals (on/off) and enable multiple clock speeds and modes (sleep, idle) to efficiently manage power on the system chip. The article then discusses several other methods that can be used to improve power management. The article mentions voltage, fabrication or process technology, and circuit design methods and libraries as the factors that can be controlled to design power efficient integrated circuits.

The processor coprocessor architectures of prior art focus on implementing complex design techniques some of which are like: a) implementing a multi-processor system or b) having a software instruction for forcing a power down mode in each of the functional blocks. Prior art has also implemented an all-hardware approach in which the processor implements power down in response to an external signal. Implementing a power down instruction for each functional block can be very expensive in terms of hardware design for the functional block and also in terms of adding new instructions each time a new functional block is added into the system. Applications like industrial instrumentation and other consumer applications need a control processor with the basic minimum DSP functionality to perform the necessary function. This functionality has to be achieved at the lowest possible cost and with minimal power consumption in the integrated electronic circuit so as to enhance the battery life in portable electronics. When used in non-battery applications, such system would result in power savings and energy conservation.

### BRIEF SUMMARY OF THE INVENTION

A sophisticated approach would be to use a combination of hardware design algorithm techniques and build power management to perform a logic function instead of doing power management based on hardware functional blocks in the integrated circuit. This solution is applicable in systems in which coprocessors are designed with minimal logic gate count using synchronous logic design techniques. If the math computations are performed in synchronous logic, the time required to perform a math computation is based on the logic 1's and logic 0's contained in the source data operands. The processor forces the math coprocessor or any other function coprocessors in freeze state when the coprocessor is not performing any requested function. Freeze state in a control processor or coprocessor makes the state machines in the logic circuits lock to a static state and hold all register contents. Freeze state is different in the sense that the processor itself is not performing any useful function but at the same time does not require an interrupt to detect completion of coprocessor operation. When the coprocessor is performing a requested function, the coprocessor will force the control processor in freeze state. By this mechanism, only one of the elements from all coprocessors and control processors will be in active state and the rest will be in freeze state. In the case of using synchronous logic math coprocessor, the control processor is in freeze state only for the time duration that is required for performing the math computation. This method can provide power savings for the system because now the time duration for which the circuits are active is optimal. Also, because the DSP coprocessor is designed with synchronous logic, the size of the integrated circuit is optimal resulting in lower integrated circuit size and low power usage.

The functions which are peripheral to the control processor can continue the normal operation if they were active before the occurrence of freeze state request for the control processor. An example of peripheral operation would be continuation of waveform generation by a functional unit peripheral to the control processor. The control processor can only communicate with the rest of the system when it is not in freeze state.

This invention describes a scheme in which significant power savings can be achieved if we implement hardware using specific design techniques and then use the hardware for techniques like DSP to achieve very low power usage. The technique described also results in logic circuits that is gate count optimal resulting in lower cost for the overall system design. The invention described is a technique to implement high performance control processor architecture while providing for DSP coprocessing at just the required power consumption levels.

### BRIEF DESCRIPTION OF THE SEVERAL VIEWS OF THE DRAWING

The features believed to be characteristic of this invention are set forth in the appended claims. The invention itself however, as well as further objects and advantages thereof, will best be understood by reference to the following detailed description of an illustrative embodiment, when read in conjunction with the accompanying drawings, wherein:

FIG. 1 is prior art and an illustration for a method to optimize a computer program to reduce power consumption.

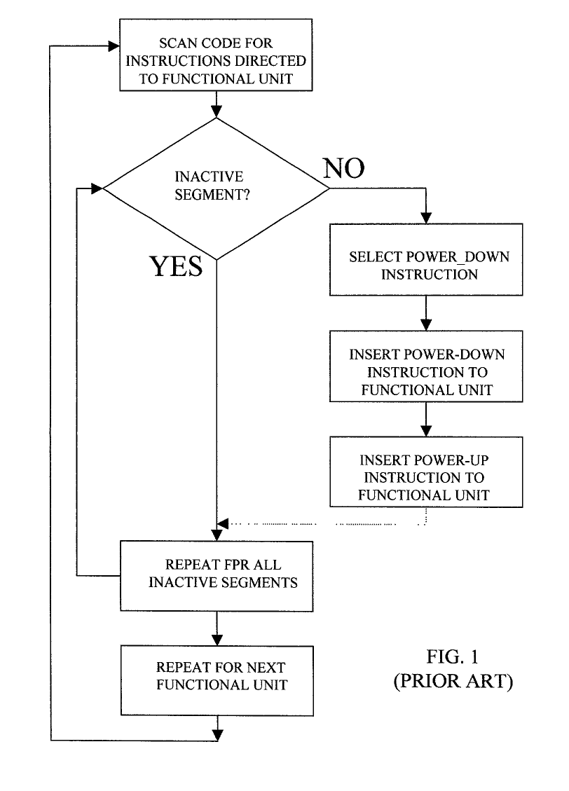

FIG. 2 is prior art and an illustration for a second scheduling method of power management.

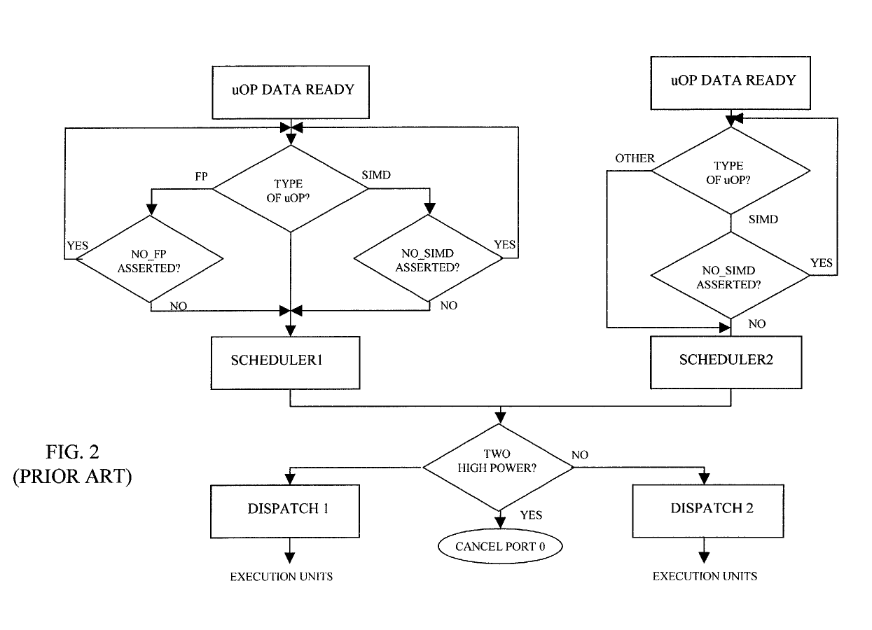

FIG. 3 is prior art and is a logic circuit diagram for auxiliary instruction decoder in microprocessor.

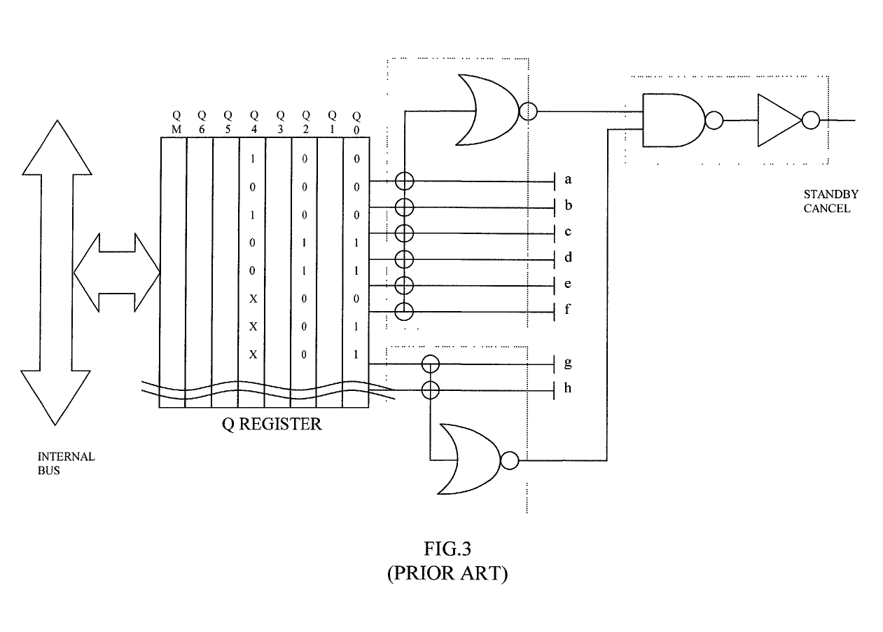

FIG. 4 is prior art and is a block diagram illustration representing implementation of power management.

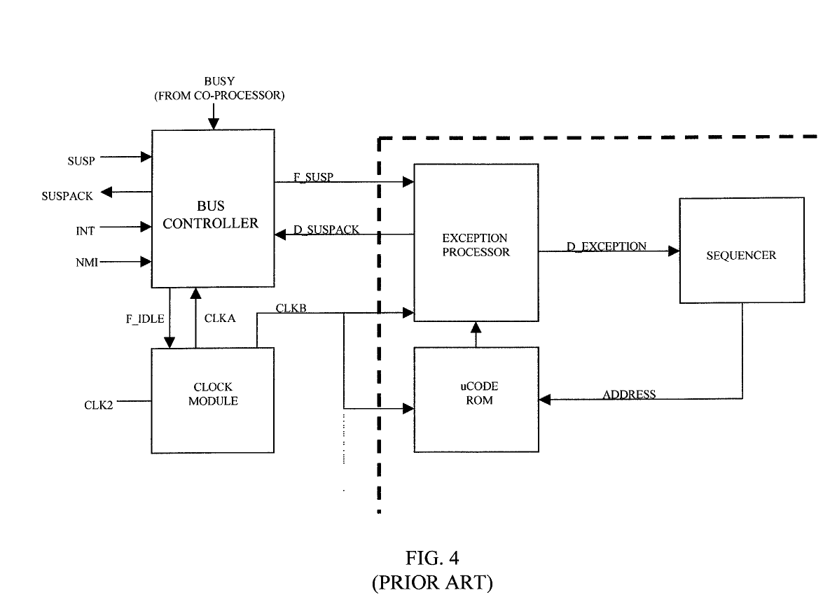

FIG. 5 is prior art and is a block diagram of a microprocessor used in a computer system.

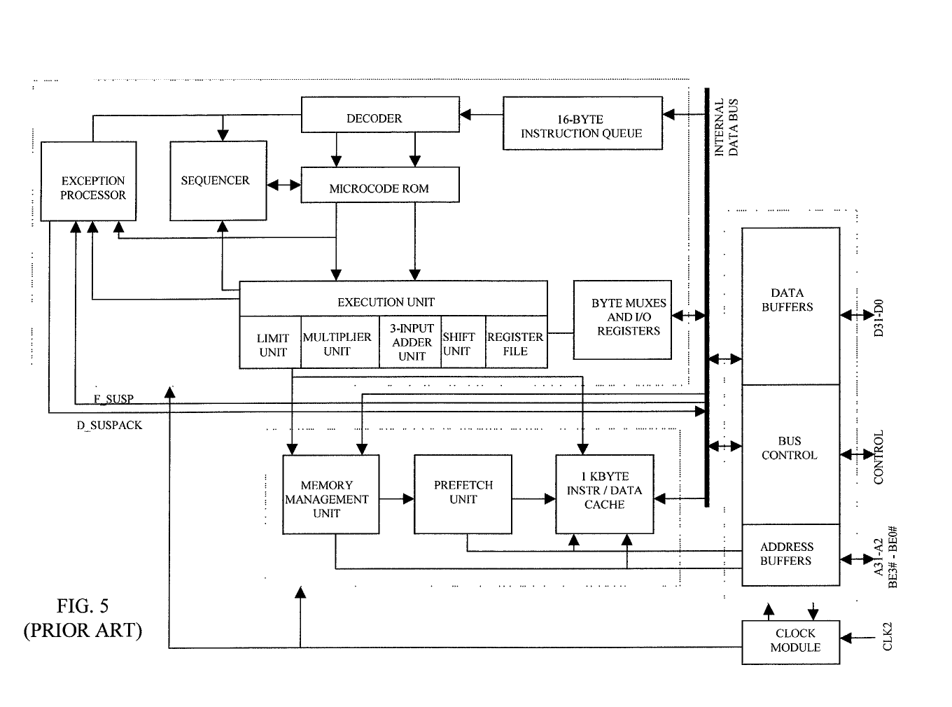

FIG. 6 is prior art and is a block diagram of an exemplary architecture of electronics within a radio.

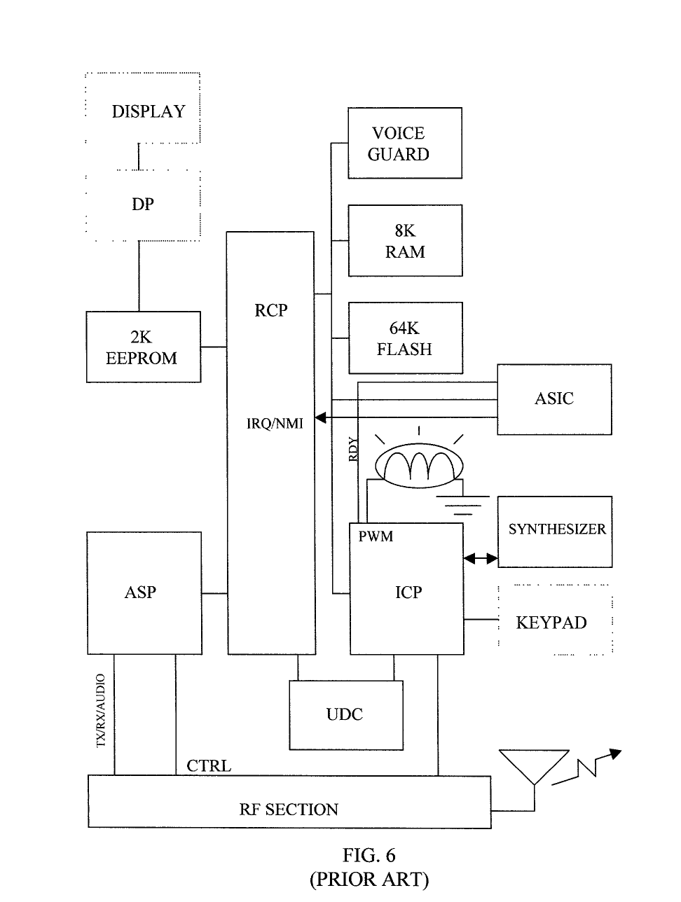

FIG. 7 is prior art and is a block diagram for a data processing system.

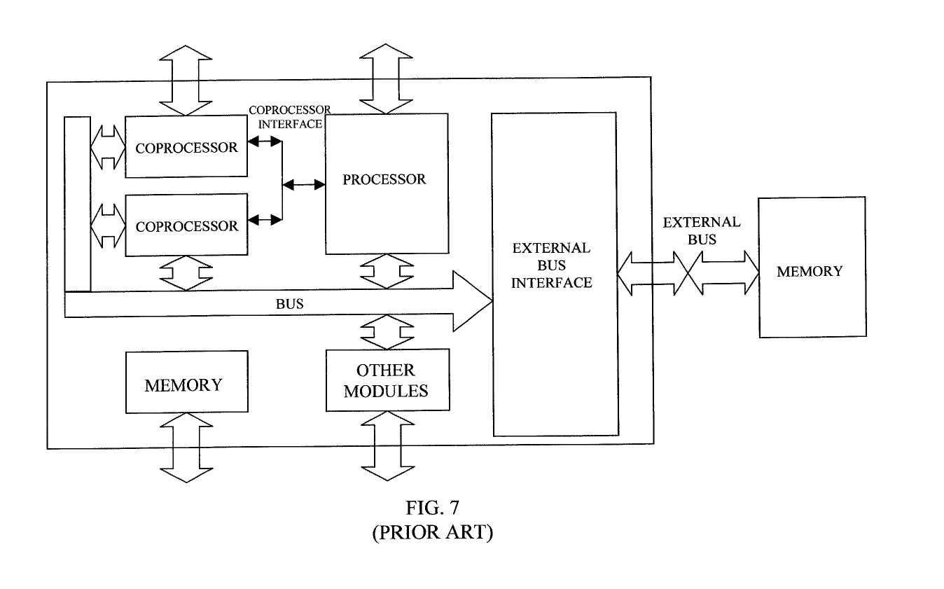

FIG. 8 is prior art and is a functional block diagram representation for a microprocessor system.

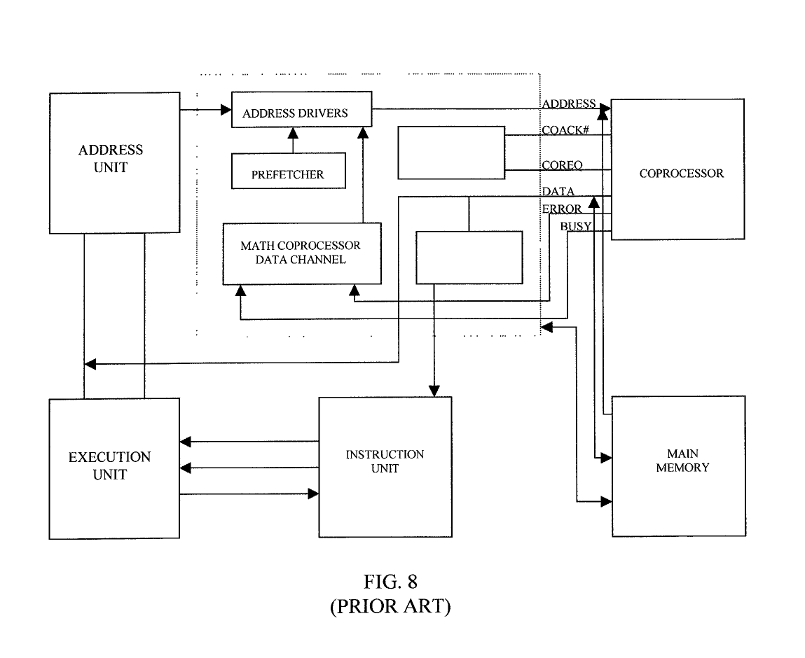

FIG. 9 is prior art and shows components of a coprocessor system using programmable latency.

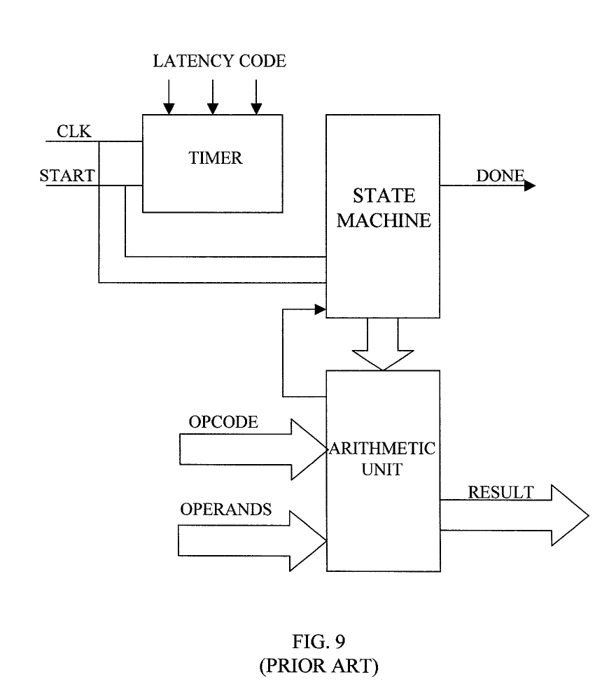

FIG. 10 is a flowchart representing different options to do DSP coprocessing in control processor environment in this invention.

FIG. 11 is program sequencing in a typical DSP algorithm implementation using processor coprocessor in this invention.

FIG. 12 is a timeline chart for power drain metrics in processor coprocessor in this invention.

### REFERENCE NUMERALS IN DRAWINGS

101 option A for software based implementation

102 option B for interrupt based implementation

103 option C for freeze state based implementation

104 polling from the control processor

105 interrupt generation in control processor

106 control processor in freeze state

107 software polling loop in control processor

108 interrupt service routine in control processor

109 coprocessor in freeze state

111 fetch data operands from memory

112 perform desired DSP math computation

121 control processor dynamic power dissipation

122 coprocessor dynamic power dissipation

### DETAILED DESCRIPTION OF THE INVENTION

The accompanying drawings, that are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention.

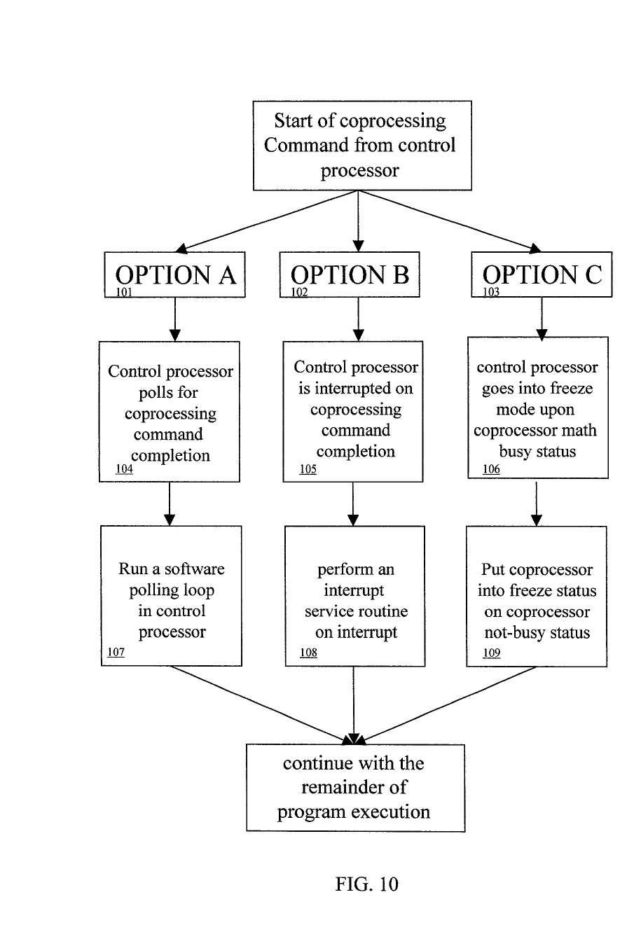

The DSP computations can be performed by the processor coprocessor architecture using various options. The flow chart diagram in FIG. 10 describes three different options and the protocols between processor and coprocessor when we have a need to perform a math computation. In option A 101, the control processor requests the DSP coprocessor that the math computation be performed. The coprocessor then begins doing the math computation. Meanwhile, the control processor polls the coprocessor 104 to determine the completion of the requested math operation. In this method of implementation, both the control processor and the coprocessor are in active state and drain power. The control processor is executing polling loop 107 on a continuous basis to find if the coprocessor has completed the requested math function.

In option B 102, the control processor requests the coprocessor to perform the math computation and then the control processor is allowed to continue with the rest of the program execution. On completion of the math computation, the coprocessor interrupts 105 the control processor to indicate completion of computation. The processor may decide to service the interrupt, ignore the interrupt, or keep the interrupt pending depending on the status of interrupt enabling and interrupt priorities. In the case of performing DSP, the control processor most likely would be requesting a successive math operation. For this to happen, the interrupt from coprocessor could be of a higher priority. In any case, the control processor would have to be ready to receive the interrupt, store the existing state of the controller and perform the interrupt servicing and then return to the main program. This option keeps both control processor and math coprocessor in active state and thus both control processor and math coprocessor functional blocks are consuming power. This also uses more number of instruction cycles because each completion of DSP coprocessor computation results in control processor performing an interrupt service routine (ISR) 108.

In option C 103, the control processor requests the math coprocessor to perform the math computation. The math coprocessor requests that the control processor go into freeze mode. All the state machines in the control processor jump to freeze state 106 in which they hold all register contents. On completing the requested math computation, the math coprocessor de-asserts the request for control processor freeze state. At this time the control processor requests that the math coprocessor go into freeze state 109. The control processor has the option of loading and requesting another math computation or continuing with the rest of the program. By this implementation scheme, the control processor and math coprocessor use optimal amount of power to perform DSP function. The is scheme takes the advantage of the fact that if the math computations are implemented using synchronous logic in hardware, the time required to complete the computations is based on logic 0's and logic 1's in the source data operands. If the math functions are implemented using synchronous logic design methods, the time required to perform math functions like normalization, binary multiplication, and binary division is data dependent.

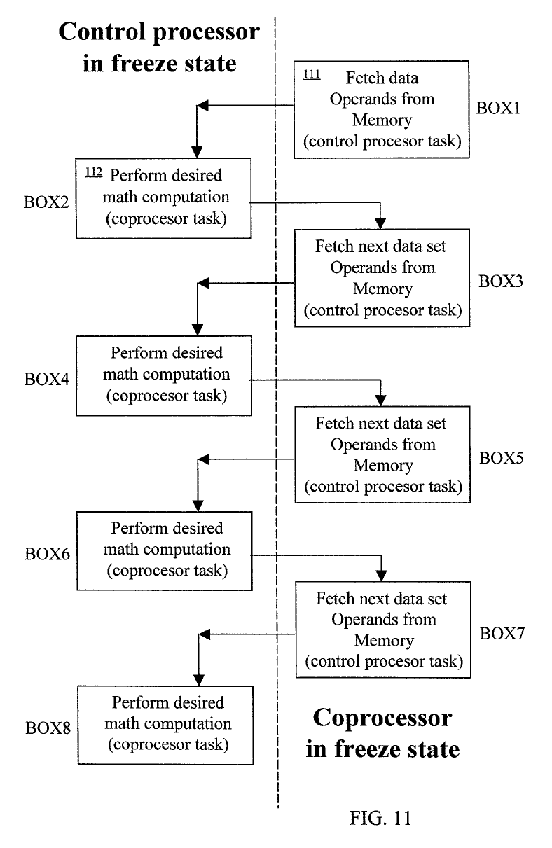

The flowchart in FIG. 11 illustrates a very typical flow that would be required to implement a filter operation with the control processor and math coprocessor scheme described in FIG. 10. As will be evident, the control processor will alternate with DSP coprocessor in doing the tasks required to accomplish the DSP task. The two main tasks identified in doing DSP computations are fetching source data operands from memory 111 and performing the math computation 112. In applications requiring this kind of processing on frequent basis, the technique described in option C of FIG. 10 is the best option for power conscious system design.

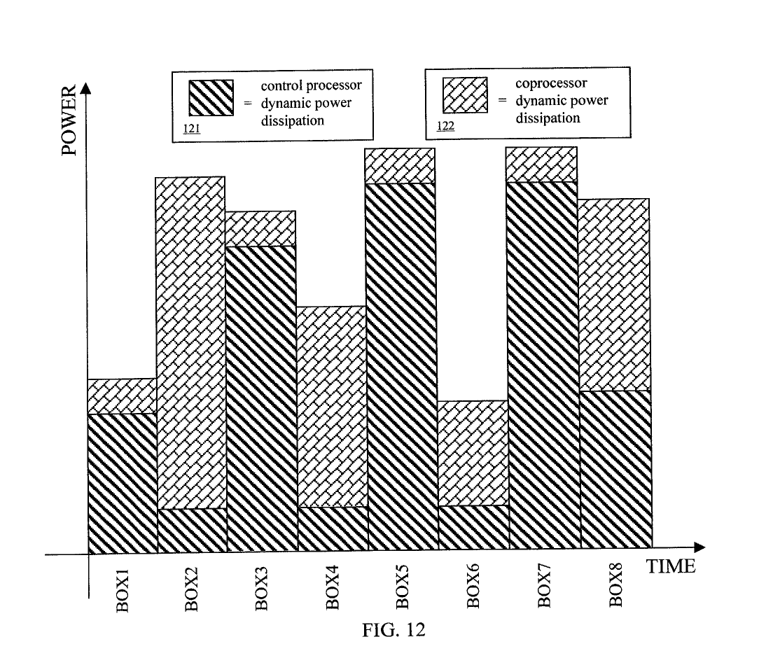

The power consumption pattern assuming that the control processor and the math coprocessor are the major blocks in the integrated circuit is as shown in FIG. 12. Please note the shading for control processor dynamic power dissipation 121 and the shading for coprocessor dynamic power dissipation 122. As will be seen, for implementing a filter operation with the control processor and math coprocessor and using the implementation of option C from FIG. 10, we could have a power pattern that corresponds to FIG. 12. The power drain for each of the boxes in FIG. 11 is identified in FIG. 12. Note that when the coprocessor is performing the math computation, the control processor is in freeze state. When the math coprocessor is done computing the requested math function, the control processor puts the math coprocessor in freeze state. Hence the power drain alternates between the two blocks for algorithms like the one described in FIG. 11. The height of the bar in FIG. 11 is different for each box because each computation can take a variable time depending on the input data operands and the computation requested.

Electronic devices that need DSP and which have some finite amount of time available to perform the DSP function can be implemented using this technique. Systems that have a need for performing DSP on real time basis, like audio and video processing, could use systems that perform math computations at a much faster rate. This invention described in FIG. 10, FIG. 11, and FIG. 12 can be used in low cost systems in which low power consumption in the device is critical. Applications like hand held industrial instruments, encryption and decryption, remote identification, storage devices, etc, are not real time systems and can potentially use this invention.

The preferred embodiment was described in the context of control processor and a DSP coprocessor. Another embodiment of this invention could include a control processor and some other functionality besides DSP math processing within the coprocessor. The preceding examples can be repeated with similar success by substituting the generically or specifically described components and operating conditions of this invention for those used in the preceding examples. Although the invention has been described in detail with particular reference to these preferred embodiments, other embodiments can achieve similar results. Variations and modifications of the present invention will be obvious to those skilled in the art and it is intended to cover all such modifications and equivalents. The entire disclosures of all references, applications, patents, and publications cited above, are hereby incorporated by reference.

### CONCLUSION, RAMIFICATIONS, AND SCOPE OF INVENTION

Accordingly, the reader will see that a low cost control processor with DSP coprocessor can be implemented using synchronous design methods and using the hardware implementation algorithms that provide optimal power management for the system. Such an integrated system can be used in industrial appliances and other consumer applications in which cost of electronics and power usage are concerns to system designers. The technique to implement hardware such that power usage is dependent on data operands in the math computation will result in gate count optimal circuit design. Gate count optimality results in higher manufacturing yields. Other coprocessing functions, if required by the system can also be implemented using similar design methods. Such computing techniques can be used with ease to create other complex math functions implemented in hardware. A higher software performance is achievable if complex math functions are available in hardware coprocessing blocks.

We claim:

1. A method of achieving power management in system comprising of control processor and coprocessor,
said method comprising the steps of:
Implementing freeze state in control processor; and
implementing freeze state in coprocessors.

2. A method of claim 1, wherein this system results in improved software performance because no wake up or interrupt mechanism is required to determine completion of coprocessor function.

3. A method of claim 1, wherein the control processor comes out of freeze state immediately after the completion of coprocessor function.

4. A method of regulating power consumption comprising:
implementing power management by control processor and coprocessors such that a control processor or any single coprocessor is exclusively in active mode while all other functions are in freeze mode.
